(19) United States
(12) Patent Application Publication
(10) Pub. No.: US 2018/0367535 A1
(43) Pub. Date: Dec. 20, 2018

(54) Method And Apparatus For Preventing Nuisance Call

(71) Applicant: HUAWEI TECHNOLOGIES CO., LTD., Shenzhen (CN)

(72) Inventors: Heng LIAO, Shenzhen (CN); Dawei HUO, Shenzhen (CN); Rongdao YU, Shenzhen (CN)

(21) Appl. No.: 16/118,627

(22) Filed: Aug. 31, 2018

Related U.S. Application Data
(63) Continuation of application No. PCT/CN2016/101261, filed on Sep. 30, 2016.

(30) Foreign Application Priority Data
Mar. 1, 2016 (CN) 201610116220.X

(51) Int. Cl. H04L 29/06; H04W 76/10; H04W 8/02

(52) U.S. Cl. CPC H04L 63/0876; H04L 63/101; H04W 8/02; H04W 76/10

(57) ABSTRACT

Embodiments of the present disclosure provide methods and apparatuses for preventing nuisance calls. An example method includes receiving, by a mobile switching center (MSC), a call request of a first terminal for calling a second terminal. In response to the mobile switching center determining that an identifier of a user of the first terminal is not in a whitelist of a user of the second terminal, obtaining, by the mobile switching center, identity information of the user of the first terminal. In response to successful authentication on the obtained identity information of the user of the first terminal, establishing, by the mobile switching center, a call link between the first terminal and the second terminal.

### CROSS-REFERENCE TO RELATED APPLICATIONS

This application is a continuation of International Application No. PCT/CN2016/101261, filed on Sep. 30, 2016, which claims priority to Chinese Patent Application No. 201610116220.X, filed on Mar. 1, 2016. The disclosures of the aforementioned applications are hereby incorporated by reference in their entireties.

### TECHNICAL FIELD

The present disclosure relates to the communications field, and provides a method and an apparatus for preventing nuisance call.

### BACKGROUND

In the last twenty years, mobile phones have become an integral part of people's lives, facilitating communication between people and improving life efficiency.

According to statistics collected on current mobile phone users, most calls picked up by users are nuisance calls. The nuisance calls include promotion calls, fraud calls, and the like. Some users even reflect that more than 80% of their picked-up calls are nuisance calls.

Currently, there are some applications for harassment blocking. According to these applications, a nuisance call is identified in a crowdsourcing manner, and prompt information is provided to a called party, so that the called party may choose to reject the call according to the prompt information. However, the nuisance call is still connected, and harassment is caused. In addition, a blacklist function of a mobile phone is used by a called party to set a phone number of a calling party. If a phone number is included in a blacklist, a call cannot be connected. Therefore, harassment is not caused. However, currently, calling parties of nuisance and fraud calls usually continuously update their phone numbers. Therefore, a method for setting a blacklist may prevent some nuisance calls, but still cannot prevent hundreds or thousands of nuisance calls.

### SUMMARY

Embodiments of the present disclosure provide a method and an apparatus for preventing nuisance call, and a system, so as to reduce a growing quantity of strange nuisance call.

According to a first aspect, an embodiment of the present disclosure provides a method for preventing nuisance call, and the method includes: receiving, by a mobile switching center (MSC), a call request of a first terminal for calling a second terminal; if the mobile switching center determines that an identifier of a user of the first terminal is not in a whitelist of a user of the second terminal, requesting and obtaining, by the mobile switching center, identity information of the user of the first terminal; and establishing, by the mobile switching center, a call link between the first terminal and the second terminal if authentication on the obtained identity information of the user of the first terminal succeeds.

In a first implementation of the first aspect, the requesting and obtaining, by the mobile switching center, identity information of the user of the first terminal includes: sending, by the mobile switching center, a request for obtaining the identity information of the user of the first terminal to the first terminal; and receiving the identity information sent by the first terminal.

With reference to the first aspect or the first implementation of the first aspect, in a second implementation of the first aspect, the requesting and obtaining, by the mobile switching center, identity information of the user of the first terminal includes: sending, by the mobile switching center, a request for obtaining the identity information of the user of the first terminal to a visitor location register (VLR) or a home location register (HLR) in a core network, where the register is configured to store the identity information of the user; and receiving the identity information of the user of the first terminal sent by the visitor location register or the home location register.

With reference to the first aspect or either of the foregoing implementations of the first aspect, in a third implementation of the first aspect, before the establishing, by the mobile switching center, a call link between the first terminal and the second terminal if authentication on the obtained identity information of the user of the first terminal succeeds, the method further includes: sending, by the mobile switching center, the identity information of the user of the first terminal to an authentication device for authentication; and receiving an authentication message sent by the authentication device, where the authentication device is a device of the user of the second terminal; and the establishing a call link between the first terminal and the second terminal if authentication on the obtained identity information of the user of the first terminal succeeds includes: if the received authentication message sent by the authentication device indicates that the authentication succeeds, establishing the call link between the first terminal and the second terminal.

With reference to the first aspect or any one of the foregoing implementations of the first aspect, in a fourth implementation of the first aspect, the sending, by the mobile switching center, the identity information of the user of the first terminal to an authentication device for authentication includes: sending, by the mobile switching center, the identity information of the user of the first terminal to a short message service center, so that the short message service center generates a call request SMS message including the identity information and sends the call request SMS message to the device of the user of the second terminal; and the receiving an authentication message sent by the authentication device includes: receiving the authentication message sent by the short message service center in a signaling manner, where the authentication message is generated according to an SMS message sent by the second terminal to the short message service center.

With reference to the first aspect or any one of the foregoing implementations of the first aspect, in a fifth implementation of the first aspect, after the receiving, by a mobile switching center, a call request of a first terminal for calling a second terminal, the method further includes: if the mobile switching center determines that the user of the first terminal is in the whitelist of the user of the second terminal, establishing, by the mobile switching center, the call link between the first terminal and the second terminal.

With reference to the first aspect or any one of the foregoing implementations of the first aspect, in a sixth implementation of the first aspect, the method further includes: if the authentication indicates that the obtained identity information of the user of the first terminal is invalid, rejecting the call request of the first terminal.

With reference to the first aspect or any one of the foregoing implementations of the first aspect, in a seventh implementation of the first aspect, the method further includes: if the authentication on the obtained identity information of the user of the first terminal succeeds, adding the identifier of the user of the first terminal to the whitelist of the user of the second terminal.

According to a second aspect, an embodiment of the present disclosure provides a method for preventing nuisance call, and the method includes: receiving, by a mobile switching center (MSC), a call request of a first terminal for calling a second terminal; and if the mobile switching center determines that a user of the first terminal is in a whitelist of a user of the second terminal, establishing, by the mobile switching center, a call link between the first terminal and the second terminal.

According to a third aspect, an embodiment of the present disclosure provides a mobile switching center apparatus for preventing nuisance call, and the apparatus includes: a call request receiving module, an identity information obtaining module, and a call establishment module, where the call request receiving module is configured to receive a call request of a first terminal for calling a second terminal; if it is determined that an identifier of a user of the first terminal is not in a whitelist of a user of the second terminal, the identity information obtaining module is configured to request and obtain identity information of the user of the first terminal; and if authentication on the obtained identity information of the user of the first terminal succeeds, the call establishment module is configured to establish a call link between the first terminal and the second terminal.

In a first implementation of the third aspect, the identity information obtaining module is configured to: send a request for obtaining the identity information of the user of the first terminal to the first terminal, and receive the identity information sent by the first terminal.

With reference to the third aspect or the first implementation of the third aspect, in a second implementation of the third aspect, the identity information obtaining module is configured to: send a request for obtaining the identity information of the user of the first terminal to a visitor location register (VLR) or a home location register (HLR) in a core network, where the register is configured to: store the identity information of the user; and receive the identity information of the user of the first terminal sent by the visitor location register or the home location register.

With reference to the third aspect or either of the foregoing implementations of the third aspect, in a third implementation of the third aspect, the apparatus further includes an authentication message module, where before the call establishment module establishes the call link between the first terminal and the second terminal, the authentication message module is configured to: send the identity information of the user of the first terminal to an authentication device for authentication, and receive an authentication message sent by the authentication device; and if the received authentication message sent by the authentication device indicates that the authentication succeeds, the call establishment module is configured to establish the call link between the first terminal and the second terminal.

With reference to the third aspect or any one of the foregoing implementations of the third aspect, in a fourth implementation of the third aspect, the authentication message module is configured to send the identity information of the user of the first terminal to a short message service center in a signaling manner, so that the short message service center generates a call request SMS message including the identity information and sends the call request SMS message to a device of the user of the second terminal; and the authentication message module is further configured to receive the authentication message sent by the short message service center in the signaling manner, where the authentication message is generated according to an SMS message sent by the second terminal to the short message service center.

With reference to the third aspect or any one of the foregoing implementations of the third aspect, in a fifth implementation of the third aspect, the call establishment module is further configured to: if the mobile switching center determines that the user of the first terminal is in the whitelist of the user of the second terminal, establish the call link between the first terminal and the second terminal.

With reference to the third aspect or any one of the foregoing implementations of the third aspect, in a sixth implementation of the third aspect, the call establishment module is further configured to: if the authentication indicates that the obtained identity information of the user of the first terminal is invalid, reject the call request of the first terminal.

With reference to the third aspect or any one of the foregoing implementations of the third aspect, in a seventh implementation of the third aspect, the apparatus further includes a whitelist management module, and if the authentication on the obtained identity information of the user of the first terminal succeeds, the whitelist management module is configured to add the identifier of the user of the first terminal to the whitelist of the user of the second terminal.

According to a fourth aspect, an embodiment of the present disclosure provides an apparatus for preventing nuisance call, and the apparatus includes: a call request receiving module and a call establishment module, where the call request receiving module is configured to receive a call request of a first terminal for calling a second terminal; and if the mobile switching center determines that a user of the first terminal is in a whitelist of a user of the second terminal, the call establishment module is configured to establish a call link between the first terminal and the second terminal.

According to a fifth aspect, an embodiment of the present disclosure provides a method for preventing nuisance call, and the method includes: receiving, by a mobile switching center (MSC), a call request of a first terminal for calling a second terminal; if the mobile switching center determines that an identifier of a user of the first terminal is not in a whitelist of a user of the second terminal, requesting and obtaining, by the mobile switching center, first identity information of the user from the first terminal, and obtaining second identity information of the user from a visitor location register (VLR) or a home location register (HLR) in a core network, where the first identity information of the user is identity information of the user of the first terminal, and the second identity information of the user is identity information of the user of the second terminal; and if the obtained first identity information of the user matches the second identity information of the user, establishing, by the mobile switching center, a call link between the first terminal and the second terminal.

According to a sixth aspect, an embodiment of the present disclosure provides a mobile switching center apparatus for preventing nuisance call, and the apparatus includes: a call request receiving module, an identity information obtaining module, and a call establishment module, where the call request receiving module is configured to receive a call request of a first terminal for calling a second terminal; if an identifier of a user of the first terminal is not in a whitelist of a user of the second terminal, the identity information obtaining module is configured to: request and obtain first identity information of the user from the first terminal, and obtain second identity information of the user from a visitor location register (VLR) or a home location register (HLR) in a core network, where the first identity information of the user is identity information of the user of the first terminal, and the second identity information of the user is identity information of the user of the second terminal; and if the obtained first identity information of the user matches the second identity information of the user, the call establishment module is configured to establish a call link between the first terminal and the second terminal.

According to a seventh aspect, an embodiment of the present disclosure provides a method for preventing nuisance call, and the method includes: receiving a call request SMS message including calling-user identity information, where the call request SMS message is generated by a short message service center according to the calling-user identity information; displaying the call request SMS message; and receiving a reply of a user to the call request SMS message, generating an SMS message, and sending the generated SMS message to the short message service center, so that the short message service center generates a signaling message according to the SMS message and sends the generated signaling message to a mobile switching center.

According to an eighth aspect, an embodiment of the present disclosure provides a terminal device for preventing nuisance call, and the terminal device includes: a call request receiving unit, a display unit, and a reply sending unit, where the call request receiving unit is configured to receive a call request SMS message including calling-user identity information, where the call request SMS message is generated by a short message service center according to the calling-user identity information; the display unit is configured to display the call request SMS message; and the reply sending unit is configured to: receive a reply of a user to the call request SMS message, generate an SMS message, and send the generated SMS message to the short message service center, so that the short message service center generates a signaling message according to the SMS message and sends the generated signaling message to a mobile switching center.

By using the methods provided in the embodiments of the present disclosure, after the mobile switching center receives the call request of the first terminal for calling the second terminal, the call link between the first terminal and the second terminal is not directly established, and whether the identifier of the user of the first terminal is in the whitelist of the user of the second terminal is determined. Therefore, a calling party who is not in a whitelist of a called party is prevented from calling the called party, thereby reducing nuisance calls. If the authentication on the obtained identity information of the user of the first terminal succeeds, the mobile switching center establishes the call link between the first terminal and the second terminal. Therefore, a call between the calling party who is not in the whitelist and the called party can be connected only when authentication on the calling party succeeds.

### BRIEF DESCRIPTION OF DRAWINGS

To describe the technical solutions in the embodiments of the present disclosure clearly, the following briefly introduces the accompanying drawings required for describing the embodiments.

FIG. 1 is a flowchart of an embodiment of a method for preventing nuisance call nuisance call according to the present disclosure;

FIG. 2 is a flowchart of another embodiment of a method for preventing nuisance call nuisance call according to the present disclosure;

FIG. 3 is a flowchart of another embodiment of a method for preventing nuisance call nuisance call according to the present disclosure;

FIG. 4 is a flowchart of another embodiment of a method for preventing nuisance call nuisance call according to the present disclosure;

FIG. 5 is a structural diagram of an embodiment of an apparatus for preventing nuisance call nuisance call according to the present disclosure;

FIG. 6 is a structural diagram of another embodiment of an apparatus for preventing nuisance call nuisance call according to the present disclosure; and

FIG. 7 is a structural diagram of an embodiment of a computer system for preventing nuisance call nuisance call according to the present disclosure.

### DESCRIPTION OF EMBODIMENTS

To make the objectives, technical solutions, and advantages of the embodiments of the present disclosure clearer, the following clearly describes the technical solutions in the embodiments of the present disclosure with reference to the accompanying drawings in the embodiments of the present disclosure.

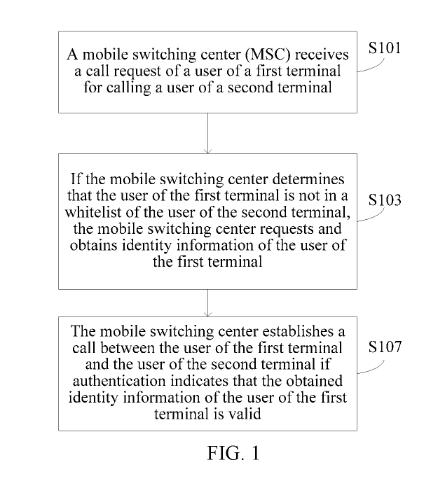

An embodiment of the present disclosure provides a method for preventing nuisance call. As shown in FIG. 1, FIG. 1 is a flowchart of an embodiment according to the present disclosure. The method includes the following steps. S101: A mobile switching center (MSC) receives a call request of a first terminal for calling a second terminal. S103: If the mobile switching center determines that an identifier of a user of the first terminal is not in a whitelist of a user of the second terminal, the mobile switching center requests and obtains identity information of the user of the first terminal. S107: The mobile switching center establishes a call link between the first terminal and the second terminal if authentication on the obtained identity information of the user of the first terminal succeeds.

The mobile switching center (MSC) is responsible for call transfer and call control in a communications system.

According to the method used in this embodiment of the present disclosure, a user of the first terminal corresponds to a calling party user, and a user of the second terminal corresponds to a called party user. The mobile switching center determines whether the calling party user is in a whitelist of the called party user. If the calling party user is not in the whitelist of the called party user, the mobile switching center obtains identity information of the calling party user. After it is determined that the identity information of the calling party user is valid, the mobile switching center establishes a call between the calling party user and the called party user. According to the method used in the present disclosure, the calling party who is not in the whitelist of the called party is prevented from calling the called party, thereby reducing nuisance calls. The call between the calling party who is not in the whitelist of the called party and the called party can be connected only when authentication on the calling party succeeds.

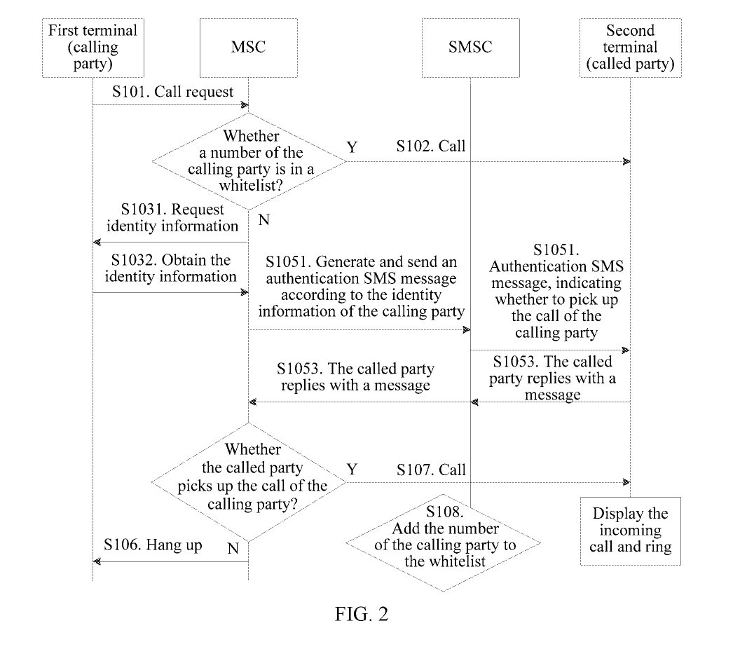

In an embodiment of the present disclosure, as shown in FIG. 2, step S103 of requesting and obtaining, by the mobile switching center, identity information of the user of the first terminal includes the following steps. S1031: The mobile switching center sends a request for obtaining the identity information of the user of the first terminal to the first terminal. S1032: Receive the identity information sent by the first terminal. In an embodiment of the present disclosure, the identity information includes name information, nickname information, location information, or signature information of the user of the first terminal, or another information that can identify the identity of the user of the first terminal. The user of the first terminal may pre-edit and store the identity information of the user of the first terminal, or enter the identity information of the user of the first terminal after step S1031. If the user of the first terminal pre-edits and stores the identity information of the user of the first terminal, the identity information of the user of the first terminal is sent without interaction of entering the identity information of the user of the first terminal. Therefore, this operation is more convenient. If the identity information of the user is obtained by entering the identity information of the calling party user by the calling party user after step S1031, the calling party user may determine whether to send the identity information of the calling party user based on the request for obtaining the identity information, so that security during sending of the identity information is improved.

In an embodiment of the present disclosure, before step S107 of establishing, by the mobile switching center, a call link between the first terminal and the second terminal if authentication on the obtained identity information of the user of the first terminal succeeds, the method further includes the following steps. S1051: The mobile switching center sends the identity information of the user of the first terminal to an authentication device for authentication. S1053: Receive an authentication message sent by the authentication device, where the authentication device is a device of the user of the second terminal. Step S1051 of sending, by the mobile switching center, the identity information of the user of the first terminal to an authentication device for authentication includes: sending, by the mobile switching center, the identity information of the user of the first terminal to a short message service center in a signaling manner, so that the short message service center generates a call request SMS message including the identity information and sends the call request SMS message to the device of the user of the second terminal. The establishing a call link between the first terminal and the second terminal if authentication on the obtained identity information of the user of the first terminal succeeds includes: if the received authentication message sent by the authentication device indicates that the authentication succeeds, establishing the call link between the first terminal and the second terminal. By using the method in this embodiment of the present disclosure, the calling party needs to participate in sending of the identity information, and the called party needs to participate in an identity information authentication process. Therefore, the identity is authenticated during the call.

The mobile switching center sends the identity information of the user of the first terminal to the short message service center, and instructs the short message service center (SMSC: Short Message Service Center) to generate an SMS message including the identity information of the user of the first terminal. The short message service center (SMSC: Short Message Service Center) sends the SMS message including the identity information of the user of the first terminal to the device of the user of the second terminal.

Before step S1053 of receiving an authentication message sent by the authentication device, the method further includes: entering, by a user of the second terminal, the authentication message indicating whether to connect the call; converting the authentication message into an SMS message, and sending, by using the short message service center, the SMS message to the mobile switching center. Alternatively, the authentication message is converted into a data SMS message such as a WeChat message, a Fetion message, or another SMS message generated by using a data SMS message application, and the data SMS message is sent to the mobile switching center by using a data exchange center.

According to the method used in this embodiment of the present disclosure, the user of the first terminal corresponds to the calling party user, and the user of the second terminal corresponds to the called party user. The mobile switching center determines whether the calling party user is in the whitelist of the called party user. If the calling party user is not in the whitelist of the called party user, the mobile switching center obtains the identity information of the calling party user. After the called party determines that the identity information of the calling party user is valid, the mobile switching center establishes a call between the calling party user and the called party user. According to the method used in the present disclosure, the calling party who is not in the whitelist of the called party is prevented from calling the called party, thereby reducing nuisance calls. The call between the calling party who is not in the whitelist of the called party and the called party can be connected only when the authentication on the calling party from the called party succeeds.

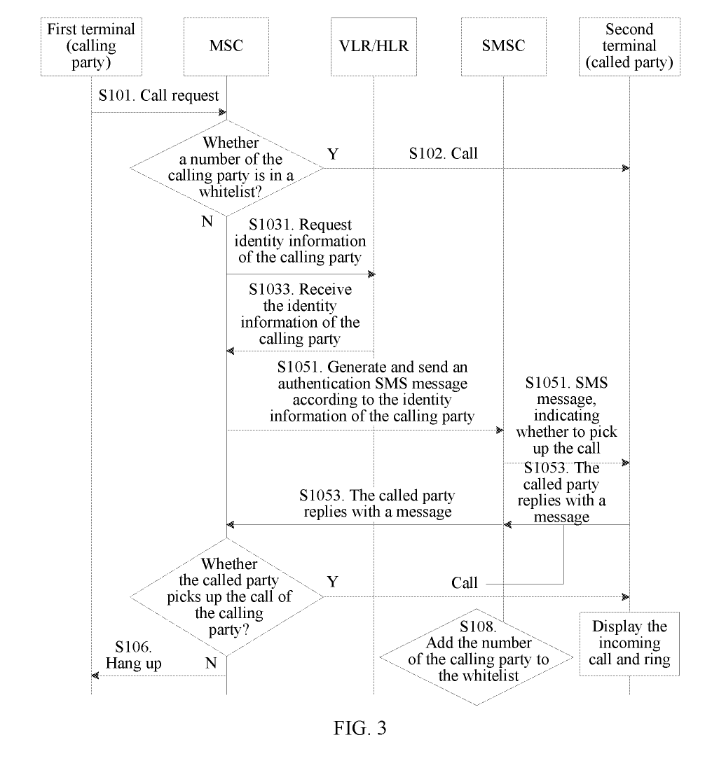

In an embodiment of the present disclosure, as shown in FIG. 3, FIG. 3 is a flowchart of another embodiment according to the present disclosure. Step S103 of requesting and obtaining, by the mobile switching center, identity information of the user of the first terminal includes the following steps. S1031: The mobile switching center sends a request for obtaining the identity information of the user of the first terminal to a visitor location register (VLR) or a home location register (HLR) in a core network, where the register is configured to store the identity information of the user. S1032: Receive the identity information of the user of the first terminal sent by the visitor location register or the home location register. In an embodiment of the present disclosure, the identity information includes name information, nickname information, location information, or signature information of the user of the first terminal, or another information that can identify the identity of the user of the first terminal. The user of the first terminal may pre-edit the identity information of the user of the first terminal and upload the identity information of the user of the first terminal to the register for storage. By using the method in this embodiment of the present disclosure, the identity information of the user of the first terminal can be sent without interaction of the user of the first terminal. In addition, compared with information requesting and obtaining between the mobile switching center and the user of the first terminal in the previous embodiment, information requesting and obtaining between the mobile switching center and the register is higher in speed and higher in efficiency.

The visitor location register or the home location register stores user-related identity information, subscription information, location information, and the like.

In an embodiment of the present disclosure, as shown in FIG. 3, before step S107 of establishing, by the mobile switching center, a call link between the first terminal and the second terminal if authentication on the obtained identity information of the user of the first terminal succeeds, the method further includes the following steps. S1051: The mobile switching center sends the identity information of the user of the first terminal to an authentication device for authentication. S1053: Receive an authentication message sent by the authentication device, where the authentication device is a device of the user of the second terminal. Step S1051 of sending, by the mobile switching center, the identity information of the user of the first terminal to an authentication device for authentication includes: sending, by the mobile switching center, the identity information of the user of the first terminal to a short message service center in a signaling manner, so that the short message service center generates a call request SMS message including the identity information and sends the call request SMS message to the device of the user of the second terminal. The establishing a call link between the first terminal and the second terminal if authentication on the obtained identity information of the user of the first terminal succeeds includes: if the received authentication message sent by the authentication device indicates that the authentication succeeds, establishing the call link between the first terminal and the second terminal. By using the method in this embodiment of the present disclosure, the calling party does not need to participate in sending of the identity information, and the called party needs to participate in an identity information authentication process. Therefore, the identity is authenticated during the call.

In an embodiment of the present disclosure, the authentication device is the device of the user (the called party) of the second terminal. The establishing a call link between the first terminal and the second terminal if authentication on the obtained identity information of the user of the first terminal succeeds includes: if the received authentication message sent by the authentication device indicates that the authentication succeeds, establishing the call link between the first terminal and the second terminal.

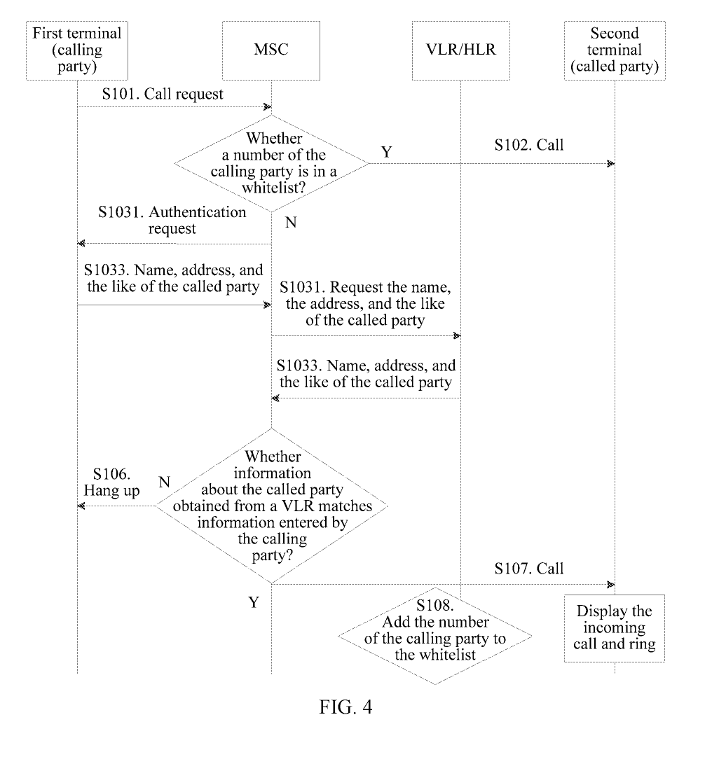

In an embodiment of the present disclosure, as shown in FIG. 4, FIG. 4 is a flowchart of an embodiment according to the present disclosure. The requesting and obtaining, by the mobile switching center, identity information of the user of the first terminal includes the following steps. S1031: The mobile switching center sends a request for obtaining the identity information of the user of the first terminal to the first terminal. S1031: The mobile switching center sends a request for obtaining the identity information of the user of the first terminal to a visitor location register (VLR) or a home location register (HLR) in a core network. S1033: Receive first identity information sent by the first terminal, and receive second identity information sent by the register.

In an embodiment of the present disclosure, step S1051 of sending, by the mobile switching center, the identity information of the user of the first terminal to an authentication device for authentication includes: sending, by the mobile switching center, the first identity information and the second identity information to the authentication device. Before the authentication on the obtained identity information of the user of the first terminal succeeds, the method further includes: if the authentication device determines that the first identity information matches the second identity information, sending an authentication success message to the mobile switching center. In an embodiment of the present disclosure, the authentication device is a device independent of the mobile switching center in the core network or a module in the mobile switching center, and is configured to perform identity authentication. By using the method provided in this embodiment of the present disclosure, whether the authentication succeeds is determined by performing matching between the first identity information sent by the calling party and the second identity information stored in the register, and the called party does not need to participate in the identity authentication. Therefore, a called party authentication process is subtracted and a procedure is simplified, thereby improving efficiency of the authentication process.

In an embodiment of the present disclosure, as shown in FIG. 2, FIG. 3, or FIG. 4, after step S101 of receiving, by a mobile switching center, a call request of a first terminal for calling a second terminal, the method further includes the following step. S102: If the mobile switching center determines that a user of the first terminal is in a whitelist of a user of the second terminal, the mobile switching center establishes a call link between the first terminal and the second terminal. By using the method in this embodiment of the present disclosure, the user of the first terminal in the whitelist can be ensured to call the user of the second terminal in time and efficiently.

In an embodiment of the present disclosure, as shown in FIG. 2, FIG. 3, or FIG. 4, if the authentication indicates that the obtained identity information of the user of the first terminal is invalid, the method further includes the following step. S106: Reject the call request of the first terminal. At the same time of, after, or before step S106, the method further includes: sending, to the first terminal, information indicating that the identity authentication fails and the call is not connected.

In an embodiment of the present disclosure, as shown in FIG. 2, FIG. 3, or FIG. 4, the method further includes the following step. S108: If the authentication on the obtained identity information of the user of the first terminal succeeds, add the identifier of the user of the first terminal to the whitelist of the user of the second terminal.

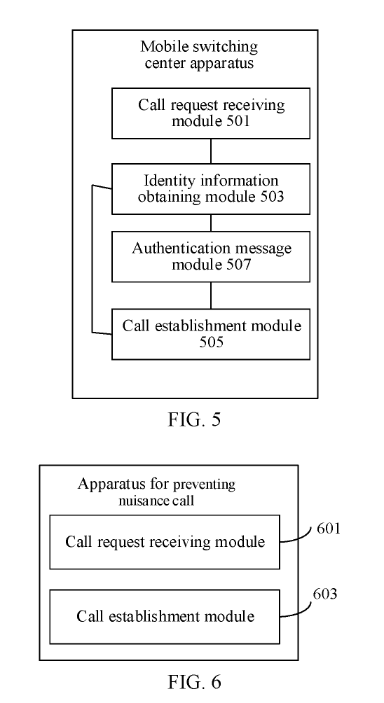

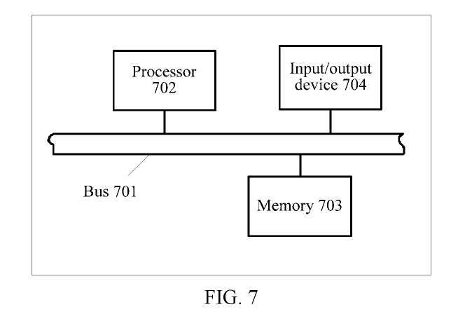

An embodiment of the present disclosure provides a mobile switching center apparatus for preventing nuisance call. As shown in FIG. 5, FIG. 5 is a structural diagram of an embodiment according to the present disclosure. The apparatus includes: a call request receiving module 501, an identity information obtaining module 503, and a call establishment module 505. The call request receiving module 501 is configured to receive a call request of a first terminal for calling a second terminal. If a user of the first terminal is not in a whitelist of a user of the second terminal, the identity information obtaining module is configured to request and obtain identity information of the user of the first terminal. If authentication on the obtained identity information of the user of the first terminal succeeds, the call establishment module 505 is configured to establish a call link between the first terminal and the second terminal.

In an embodiment of the present disclosure, the identity information obtaining module 503 is configured to: send a request for obtaining the identity information of the user of the first terminal to the first terminal, and receive the identity information sent by the first terminal.

In an embodiment of the present disclosure, the identity information obtaining module 503 is configured to: send a request for obtaining the identity information of the user of the first terminal to a visitor location register (VLR) or a home location register (HLR) in a core network. The register is configured to: store the identity information of the user; and receive the identity information of the user of the first terminal sent by the visitor location register or the home location register.

In an embodiment of the present disclosure, the apparatus further includes an authentication message module 507. Before the call establishment module 505 establishes the call link between the first terminal and the second terminal, the authentication message module 507 is configured to: send the identity information of the user of the first terminal to an authentication device for authentication, and receive an authentication message sent by the authentication device. The authentication device is a device of the user of the second terminal. The authentication message module 507 is configured to send the identity information of the user of the first terminal to a short message service center in a signaling manner, so that the short message service center generates a call request SMS message including the identity information and sends the call request SMS message to the device of the user of the second terminal. If the received authentication message sent by the authentication device indicates that the authentication succeeds, the call establishment module 505 is configured to establish the call link between the first terminal and the second terminal.

In an embodiment of the present disclosure, the identity information obtaining module 503 is configured to: send a request for obtaining the identity information of the user of the first terminal to the first terminal, and send a request for obtaining the identity information of the user of the first terminal to a visitor location register (VLR) or a home location register (HLR) in a core network; and receive first identity information sent by the first terminal, and receive second identity information sent by the register.

In an embodiment of the present disclosure, the apparatus further includes an authentication message module 507. The authentication message module 507 is configured to: send the first identity information and the second identity information to an authentication device, receive an authentication success message sent by the authentication device, and forward the authentication success message to the call establishment module 505. If determining that the first identity information matches the second identity information, the authentication device sends the authentication success message to the authentication message module 507.

In an embodiment of the present disclosure, the apparatus further includes an authentication message module 507. The authentication message module 507 is configured to: determine whether the first identity information matches the second identity information; and if the first identity information matches the second identity information, generate an authentication success message, and send the authentication success message to the call establishment module 505.

In an embodiment of the present disclosure, the call establishment module 505 is further configured to: if the mobile switching center determines that the user of the first terminal is in the whitelist of the user of the second terminal, establish the call link between the first terminal and the second terminal.

In an embodiment of the present disclosure, the call establishment module 505 is further configured to: if the authentication indicates that the obtained identity information of the user of the first terminal is invalid, reject the call request of the first terminal.

In an embodiment of the present disclosure, the apparatus further includes a whitelist management module, and if the authentication on the obtained identity information of the user of the first terminal succeeds, the whitelist management module is configured to add the identifier of the user of the first terminal to the whitelist of the user of the second terminal.

In an embodiment of the present disclosure, as shown in FIG. 6, the present disclosure provides an apparatus for preventing nuisance call, and the apparatus includes a call request receiving module 601 and a call establishment module 603. The call request receiving module is configured to receive a call request of a first terminal for calling a second terminal. If the mobile switching center determines that a user of the first terminal is in a whitelist of a user of the second terminal, the call establishment module 603 is configured to establish a call link between the first terminal and the second terminal.

An embodiment of the present disclosure provides a method for preventing nuisance call, and the method includes: receiving, by a mobile switching center (MSC), a call request of a first terminal for calling a second terminal; if the mobile switching center determines that an identifier of a user of the first terminal is not in a whitelist of a user of the second terminal, requesting and obtaining, by the mobile switching center, first identity information of the user from the first terminal, and obtaining second identity information of the user from a visitor location register (VLR) or a home location register (HLR) in a core network, where the first identity information of the user is identity information of the user of the first terminal, and the second identity information of the user is identity information of the user of the second terminal; and if the obtained first identity information of the user matches the second identity information of the user, establishing, by the mobile switching center, a call link between the first terminal and the second terminal.

By using the method provided in this embodiment of the present disclosure, a called terminal locally maintains a whitelist of a user. If an identifier of a user of a calling party is not in the whitelist of the called terminal, the called terminal requests identity information of the calling party from the core network. If obtained first identity information of the user matches second identity information of the user, it indicates that the calling party has correct called party information, thereby preventing harassment to the called party's life caused by a group call or random call from a calling party (for example, an advertising promotion call, an intermediary call, a nuisance call) who does not know the real identity of the called party. By using the method provided in this embodiment of the present disclosure, the calling party does not need to participate, and only the called party needs to participate, thereby improving calling experience of the calling party.

An embodiment of the present disclosure provides a mobile switching center apparatus for preventing nuisance call, and the apparatus includes: a call request receiving module, an identity information obtaining module, and a call establishment module. The call request receiving module is configured to receive a call request of a first terminal for calling a second terminal. If an identifier of a user of the first terminal is not in a whitelist of a user of the second terminal, the identity information obtaining module is configured to: request and obtain first identity information of the user from the first terminal, and obtain second identity information of the user from a visitor location register (VLR) or a home location register (HLR) in a core network. The first identity information of the user is identity information of the user of the first terminal, and the second identity information of the user is identity information of the user of the second terminal. If the obtained first identity information of the user matches the second identity information of the user, the call establishment module is configured to establish a call link between the first terminal and the second terminal.

An embodiment of the present disclosure provides a method for preventing nuisance call, and the method includes: receiving a call request SMS message including calling-user identity information, where the call request SMS message is generated by a short message service center according to the calling-user identity information; displaying the call request SMS message; and receiving a reply of a user to the call request SMS message, generating an SMS message, and sending the generated SMS message to the short message service center, so that the short message service center generates a signaling message according to the SMS message and sends the generated signaling message to a mobile switching center.

An embodiment of the present disclosure provides a terminal device for preventing nuisance call, and the terminal device includes: a call request receiving unit, a display unit, and a reply sending unit. The call request receiving unit is configured to receive a call request SMS message including calling-user identity information. The call request SMS message is generated by a short message service center according to the calling-user identity information. The display unit is configured to display the call request SMS message; and the reply sending unit is configured to: receive a reply of a user to the call request SMS message, generate an SMS message, and send the generated SMS message to the short message service center, so that the short message service center generates a signaling message according to the SMS message and sends the generated signaling message to a mobile switching center. By using the method provided in this embodiment of the present disclosure, after a called terminal receives a call request, a called party can determine whether to pick up a call according to identity information of the user sent by the calling party, thereby reducing nuisance call nuisance call to the called party.

An embodiment of the present disclosure provides a computer system for preventing nuisance call, and the computer system includes: a bus 701, a processor 702, a memory 703, and an input/output device 704. The processor, the memory, and the input/output device are connected by using the bus. The memory is configured to store data and code. The processor is coupled to the memory, and implements the following method by invoking the data and the code of the memory: receiving, by a mobile switching center (MSC), a call request of a first terminal for calling a second terminal; if the mobile switching center determines that an identifier of a user of the first terminal is not in a whitelist of a user of the second terminal, requesting and obtaining, by the mobile switching center, identity information of the user of the first terminal; and establishing, by the mobile switching center, a call link between the first terminal and the second terminal if authentication on the obtained identity information of the user of the first terminal succeeds.

In an embodiment of the present disclosure, the input/output device 704 includes a text input device such as a keyboard, a touchscreen, and a mouse, a camera, a touching module, and the like. The processor coupled to the memory is further configured to: invoke a program or the data in the memory to control the camera to collect an image of a first object, where the first object is a part of a human body; and control the touching module to apply the touching signal to the first object.

A person skilled in the art may understand that the accompanying drawings are merely schematic diagrams of examples of embodiments, and modules or processes in the accompanying drawings are not necessarily required for implementing the present disclosure.

A person skilled in the art may understand that the modules in the apparatuses provided in the embodiments may be arranged in the apparatuses in a distributed manner according to the description of the embodiments, or may be arranged in one or more apparatuses which are different from those described in the embodiments. The modules in the foregoing embodiments may be combined into one module, or split into a plurality of submodules.

A person of ordinary skill in the art may understand that all or a part of the steps of the methods in the embodiments may be implemented by a program instructing relevant hardware. The program may be stored in a computer readable storage medium, including a ROM, a RAM, a magnetic disk, or an optical disc.

Finally, it should be noted that the foregoing embodiments are merely intended for describing the technical solutions of the present disclosure but not for limiting the present disclosure. Although the present disclosure is described in detail with reference to the foregoing embodiments, persons of ordinary skill in the art should understand that they may still make modifications to the technical solutions described in the foregoing embodiments or make equivalent replacements to some technical features thereof, without departing from the spirit and scope of the technical solutions of the embodiments of the present disclosure.

1. A method for preventing nuisance call, wherein the method comprises:
receiving, by a mobile switching center (MSC), a call request of a first terminal for calling a second terminal;
in response to the mobile switching center determining that an identifier of a user of the first terminal is not in a whitelist of a user of the second terminal, obtaining, by the mobile switching center, identity information of the user of the first terminal; and
in response to successful authentication on the obtained identity information of the user of the first terminal, establishing, by the mobile switching center, a call link between the first terminal and the second terminal.

2. The method according to claim 1, wherein the obtaining, by the mobile switching center, identity information of the user of the first terminal comprises:
sending, by the mobile switching center, a request for obtaining the identity information of the user of the first terminal to the first terminal; and
receiving the identity information sent by the first terminal.

3. The method according to claim 1, wherein the obtaining, by the mobile switching center, identity information of the user of the first terminal comprises:
sending, by the mobile switching center, a request for obtaining the identity information of the user of the first terminal to a visitor location register (VLR) or a home location register (HLR) in a core network, wherein the register is configured to store the identity information of the user; and
receiving the identity information of the user of the first terminal sent by the visitor location register or the home location register.

4. The method according to claim 2, wherein, before the establishing, by the mobile switching center, a call link between the first terminal and the second terminal, the method further comprises:
sending, by the mobile switching center, the identity information of the user of the first terminal to an authentication device for authentication; and
receiving an authentication message sent by the authentication device, wherein the authentication device is a device of the user of the second terminal; and
wherein the establishing a call link between the first terminal and the second terminal comprises:
establishing the call link between the first terminal and the second terminal if the received authentication message sent by the authentication device indicates that the authentication succeeds.

5. The method according to claim 4, wherein:
the sending, by the mobile switching center, the identity information of the user of the first terminal to an authentication device for authentication comprises:
sending, by the mobile switching center, the identity information of the user of the first terminal to a short message service center, wherein the short message service center generates a call request SMS message comprising the identity information and sends the call request SMS message to the device of the user of the second terminal; and
the receiving an authentication message sent by the authentication device comprises:
receiving the authentication message sent by the short message service center in a signaling manner, wherein the authentication message is generated according to an SMS message sent by the second terminal to the short message service center.

6. The method according to claim 1, wherein the method further comprises:
in response to the authentication indicating that the obtained identity information of the user of the first terminal is invalid, rejecting the call request of the first terminal.

7. The method according to claim 1, wherein the method further comprises:
in response to successful authentication on the obtained identity information of the user of the first terminal, adding the identifier of the user of the first terminal to the whitelist of the user of the second terminal.

8. A method for preventing nuisance call, wherein the method comprises:
receiving, by a mobile switching center (MSC), a call request of a first terminal for calling a second terminal; and
in response to the mobile switching center determining that a user of the first terminal is in a whitelist of a user of the second terminal, establishing, by the mobile switching center, a call link between the first terminal and the second terminal.

9. A mobile switching center apparatus for preventing nuisance call, wherein the apparatus comprises:
a non-transitory memory storage comprising instructions;
one or more hardware processors in communication with memory storage, wherein the one or more hardware processors execute the instructions to:
receive a call request of a first terminal for calling a second terminal;
in response to determining that an identifier of a user of the first terminal is not in a whitelist of a user of the second terminal, obtain identity information of the user of the first terminal; and
in response to successful authentication on the obtained identity information of the user of the first terminal, establish a call link between the first terminal and the second terminal.

10. The apparatus according to claim 9, wherein the one or more hardware processors execute the instructions to:
send a request for obtaining the identity information of the user of the first terminal to the first terminal; and
receive the identity information sent by the first terminal.

11. The apparatus according to claim 9, wherein the one or more hardware processors execute the instructions to:
send a request for obtaining the identity information of the user of the first terminal to a visitor location register (VLR) or a home location register (HLR) in a core network, wherein the register is configured to store the identity information of the user; and
receive the identity information of the user of the first terminal sent by the visitor location register or the home location register.

12. The apparatus according to claim 10, wherein the one or more hardware processors execute the instructions to:
before establishing the call link between the first terminal and the second terminal:
send the identity information of the user of the first terminal to an authentication device for authentication; and
receive an authentication message sent by the authentication device; and
establish the call link between the first terminal and the second terminal if the received authentication message sent by the authentication device indicates that the authentication succeeds.

13. The apparatus according to claim 12, wherein:
sending the identity information of the user of the first terminal to an authentication device for authentication comprises sending the identity information of the user of the first terminal to a short message service center in a signaling manner, wherein the short message service center generates a call request SMS message comprising the identity information and sends the call request SMS message to a device of the user of the second terminal; and
receiving the authentication message sent by the authentication device comprises receiving the authentication message sent by the short message service center in the signaling manner, wherein the authentication message is generated according to an SMS message sent by the second terminal to the short message service center.

14. The apparatus according to claim 9, wherein the one or more hardware processors execute the instructions to, in response to the authentication indicating that the obtained identity information of the user of the first terminal is invalid, reject the call request of the first terminal.

15. The apparatus according to claim 9, wherein the one or more hardware processors execute the instructions to, in response to successful authentication on the obtained identity information of the user of the first terminal, add the identifier of the user of the first terminal to the whitelist of the user of the second terminal.

16. An apparatus for preventing nuisance call, wherein the apparatus comprises:
a non-transitory memory storage comprising instructions;
one or more hardware processors in communication with memory storage, wherein the one or more hardware processors execute the instructions to:
receive a call request of a first terminal for calling a second terminal; and
in response to determining that a user of the first terminal is in a whitelist of a user of the second terminal, establish a call link between the first terminal and the second terminal.

17. A method for preventing nuisance call, wherein the method comprises:
receiving, by a mobile switching center (MSC), a call request of a first terminal for calling a second terminal;
in response to the mobile switching center determining that an identifier of a user of the first terminal is not in a whitelist of a user of the second terminal, obtaining, by the mobile switching center, first identity information of the user from the first terminal, and obtaining second identity information of the user from a visitor location register (VLR) or a home location register (HLR) in a core network, wherein the first identity information of the user is identity information of the user of the first terminal, and wherein the second identity information of the user is identity information of the user of the second terminal; and
in response to determining that the obtained first identity information of the user matches the second identity information of the user, establishing, by the mobile switching center, a call link between the first terminal and the second terminal.

18. A mobile switching center apparatus for preventing nuisance call, wherein the apparatus comprises:
a non-transitory memory storage comprising instructions;
one or more hardware processors in communication with memory storage, wherein the one or more hardware processors execute the instructions to:
receive a call request of a first terminal for calling a second terminal;
in response to determining that an identifier of a user of the first terminal is not in a whitelist of a user of the second terminal, obtain first identity information of the user from the first terminal, and obtain second identity information of the user from a visitor location register (VLR) or a home location register (HLR) in a core network, wherein the first identity information of the user is identity information of the user of the first terminal, and wherein the second identity information of the user is identity information of the user of the second terminal; and
in response to determining that the obtained first identity information of the user matches the second identity information of the user, establish a call link between the first terminal and the second terminal.

19. A method for preventing nuisance call, wherein the method comprises:
receiving a call request SMS message comprising calling-user identity information, wherein the call request SMS message is generated by a short message service center according to the calling-user identity information;
displaying the call request SMS message; and
receiving a reply of a user to the call request SMS message, and, in response to receiving the reply, generating an SMS message and sending the generated SMS message to the short message service center, wherein the short message service center generates a signaling message according to the SMS message and sends the generated signaling message to a mobile switching center.

20. A terminal device for preventing nuisance call, wherein the terminal device comprises:
a non-transitory memory storage comprising instructions;
one or more hardware processors in communication with memory storage, wherein the one or more hardware processors execute the instructions to:
receive a call request SMS message comprising calling-user identity information, wherein the call request SMS message is generated by a short message service center according to the calling-user identity information;
display the call request SMS message; and
receive a reply of a user to the call request SMS message, and, in response to receiving the reply, generate an SMS message and send the generated SMS message to the short message service center, wherein the short message service center generates a signaling message according to the SMS message and sends the generated signaling message to a mobile switching center.
